(19) United States
(12) Patent Application Publication
(10) Pub. No.: US 2014/0043163 A1
(43) Pub. Date: Feb. 13, 2014

(54) ASSET PROTECTION SYSTEM

(71) Applicant: Xiao Hui Yang, Saratoga, CA (US)

(72) Inventor: Xiao Hui Yang, Saratoga, CA (US)

(21) Appl. No.: 14/056,906

(22) Filed: Oct. 17, 2013

Related U.S. Application Data
(63) Continuation-in-part of application No. 12/391,252, filed on Feb. 23, 2009, now abandoned.
(60) Provisional application No. 61/030,932, filed on Feb. 22, 2008.
(60) Provisional application No. 61/030,929, filed on Feb. 22, 2008.

(51) Int. Cl. G08B 13/24

(52) U.S. Cl. CPC G08B 13/2462
USPC 340/572.1

(57) ABSTRACT

An asset protection system uses a plurality of radiate and detect units to maintain a radio frequency field, or signal, in a monitored area. Each unit has a unique unit identifier code which it modulates onto its transmission of the field, and a zone where its transmission of the field will dominate. Assets have tags attached to them. The tags have a mechanism to attach them to the objects and have electronic components on board including a microprocessor, motion detector, radio frequency circuitry, audible alarm generator. The tags receive the field and when they are in a zone dominated by a unit, demodulate that units identifier code. The tags transmit a signal at a different frequency with the unit identifier code and its tag identifier code in the signal. The unit receives the tag signal with its code on it and adds the tag to the inventory for its area.

### CROSS REFERENCE TO RELATED APPLICATIONS

This application is a continuation-in-part application based on U.S. patent application Ser. No. 12/391,252 filed on Feb. 23, 2009, in turn claiming priority to U.S. Provisional Application 61/030,932, filed on Feb. 22, 2008, and U.S. Provisional Application 61/030,929 filed on Feb. 22, 2008. The entire disclosures contained in U.S. patent application Ser. No. 12/391,252, U.S. Provisional Application 61/030,932, and U.S. Provisional Application 61/030,929, including the attachments thereto, are incorporated herein by reference.

### FIELD OF INVENTION

The present application is generally related to asset protection and tracking. Some embodiments of the system may relate more specifically to the prevention of theft of assets, including the prevention of theft of retail items. Some embodiments of the system may relate more specifically to tracking individual persons by using asset tracking processes. The several embodiments in the present application comprise both an overall system as well as tags used in that system by being attached to the tracked articles and may be considered to be generally in the field of radio frequency based electronic article surveillance (EAS).

Also, various embodiments of tags of the present application may be used with various electronic article surveillance (EAS) systems in addition to the system of the present application, including for example, an EAS system utilizing tags and deactivators featuring infrared communication for deactivation and alarming and featuring dynamic time based passcode modification and other tamper resistant features, and/or an EAS system using passive EAS element technology.

### RELEVANT ART

U.S. Pat. No. 4,686,513 by Farrar et al. is for an “Electronic surveillance using self-powered article attached tags”. Alarm tags releasably attachable to articles to be monitored in a retail installation or the like have enhanced operational capabilities giving rise to an improved likelihood of detection of article theft. The system has a transmitter unit which radiates signals containing diverse message contents. The tags each include an attachment device for releasably securing the tag to an article, a receiver unit for receiving such radiated signals and decoding the messages therein, an alarm unit and a signal processor, the latter being responsive to the state of the attachment device and to decoded messages for selectively operating the alarm unit to provide sensible output alarm indication. In a preferred embodiment, the system includes a transmitter in an exit area of the retail installation which radiates a signal containing a first message for receipt only by tags in such area and has a transmitter in a checkout area which radiates signals containing various selectable messages for article checkout purposes.

U.S. Pat. No. 5,083,111 by Drucker et al. is for a “Jamming Apparatus for Electronic Article Surveillance Systems”. In an electronic article surveillance system, a jamming apparatus is provided for establishing a jamming zone in which tags can be situated and not respond to message signals from a surveillance system transmitter and in which the surveillance system receiver can be situated and still respond to tag signals.

U.S. Pat. No. 5,245,317 by Chidley et al. is for an “Article theft detection apparatus”. A method and system are provided for monitoring an item within a defined area and sounding an alarm if the item is removed from the area. A transmitter and transducers emit ultrasound which substantially saturates the area to be monitored. A security tag having a detector and alarm is attached to the items to be monitored within the area. Sensing circuits may be additionally provided to determine whether a security tag is being tampered with or removed by an unauthorized person. The security tag's alarm is sounded in the event that the receiver does not detect the ultrasound indicating that the monitored item is no longer in the monitored area. Additional alarms may be provided for indicating that the security tag has been tampered with or removed.

U.S. Pat. No. 4,797,659 by Larsen is for a “Method and a Unit for Synchronizing Burglary Detectors”. A method and a unit synchronizes a system for detecting passage of an article through a predetermined area to the mains power wave thereto. The system has a transmitter and a receiver alternately transmitting and receiving electro-magnetic signals as well as a marker secured to the article for receiving said signal and transmitting other signals during article passage of the area. In this manner, undesired interference with a neighboring, like system, is avoided, without the interconnection therebetween, because the existing mains network is employed for the synchronizing.

U.S. Pat. No. 5,995,002 by Fallin et al. is for “Line Synchronized Delays for Multiple Pulsed EAS Systems”. A method for initializing an electronic article surveillance (EAS) system which transmits pulses into an interrogation zone and receives signals from the interrogation zone in a sequence of multiple successive transmit and receive windows during each line period of an AC mains supply energizing the EAS system, associated with a corresponding apparatus, comprises the steps of: (a.) determining whether a delay value is stored in a nonvolatile memory; (b.)if the delay value is stored in the nonvolatile memory, loading the stored delay value into a delay control register, terminating the initializing and omitting all remaining steps; (c.) if the delay value is not stored in the nonvolatile memory, loading a first delay value into the delay control register; (d.) determining whether noise in a certain receive window is less than a threshold level; (e.) if the noise is less than the threshold level, terminating the initializing and omitting all remaining steps; (f.) if the noise level is not less than the threshold level, loading a second delay value into the delay control register; (g.) determining if the EAS system is operating properly; (h.) if the EAS system is operating properly, terminating the initializing and omitting all remaining steps; (i.) if the EAS system is not operating properly, loading the first delay value into the delay control register; and, (j.) terminating the initializing.

Systems that rely on frequent or consistent signals from tags exacerbate limitations of the tags. Transmitting a radio frequency signal places a high demand on the power supply of a tag, and the quality of the signal from a tag is highly dependent upon the orientation of the tag. Because of this, even more power may be needed from a power supply to compensate for a tags deviation from the optimum orientation, particularly when the component of the system receiving a signal from a tag, is at some distance from the tag. The power supply is most typically a battery. The larger the distance between a transmitting object and a receiving object, the stronger the original signal needs to be and the more power required. This distance factor requires either more power for the tag transmitter or a large number of receiving antennas, or some combination of both. Greater power requirements for the tag decrease tag life. Larger numbers of antennas or large antennas add to the cost of the system.

Other limitations of prior art systems involve coordinating transmissions from multiple tags. Depending on the particular regulatory regime, a system will operate at a given frequency and monitor that frequency for communication from the several tags located in a monitored area. If the tags transmit at the same time, their signals will interfere with each other. In order for prior art systems to track tags and the associated products, the tags must periodically check in with the system via transmissions at the particular frequency. When systems employ multiple tags transmitting information back to the broader system, various schemes need to be employed to ensure that tag signals don't interfere with each other, so that the system can receive the tag signals. This adds complexity to the system, and the scheduled transmissions from the tags consume energy which shortens tag life. The frequent tag transmissions required by these schemes and the need for adequately powered tag signals leads to a limited life for the power source and therefore unsatisfactory tag longevity. Hence there is a need for a system facilitating long battery life for both economical and efficacy reasons.

### SUMMARY OF EMBODIMENTS OF THE INVENTION

Embodiments of the present invention are for a radio frequency based tracking systems and tags, either for anti-theft electronic article surveillance, or for tracking of persons, etc. Multiple radiate and detect units (RADs) monitor an area by transmitting a signal field into the monitored area and the tags receive the signal and are capable of communicating with the RADs. The tags have the ability to generate an alarm signal under alarm conditions. These alarm conditions may indicate theft or the presence or absence of a person from particular areas. The systems operating with these tags facilitate a long battery life for the batteries powering the tags.

Assets that are to be monitored have the tags releasably attached to them. Each tag has a unique identification code and the tag is registered in the system along with information about the asset to which it is attached. The assets are placed in an area protected by the EAS system. The system generally saturates the protected area with a radio frequency signal using multiple radiate and detect units. In one embodiment the radiate and detect units, RADs, have at least a programmable controller, memory, signal transmitting and receiving means, and a cable receptacle for receiving a cable for transmitting power and data. The RAD units can be mounted overhead to place them out of the way.

The RADs transmit on the same frequency and are synchronized with each other to transmit at the same time. Although they transmit on the same frequency and are synchronized with each other, each RAD unit modulates its own unique identifier onto the RF signal, or field. For the most part, within its own zone, each RAD's field will dominate and the field will carry its unique ID. In areas where zones of more than one RAD overlap in a way that causes their fields to have equal strength, the signals will interfere with each other and create a grey area where the respective ID codes cannot be decoded from the field.

Various embodiments of the tags may comprise: a microprocessor; a motion sensor; a radio frequency communication circuitry; an audible alarm generator; a battery powering the foregoing elements; an attaching mechanism for releaseably attaching the tag to an object, and sometimes a locking device associated with the attaching mechanism; switches associated with the attaching mechanism and locking device; and some embodiments may include a passive EAS element. Some embodiments of the tags may also employ optical communication ports such as infra-red communication ports and diodes.

The electronic components powered by the battery perform several logic and communication functions. The microprocessor is capable of storing and executing programmed instructions. When present in an embodiment of tag, the motion sensor functions to determine when the tag is being moved. The motion sensor may actually detect motion, or the motion sensor may monitor the orientation of the tag, for example, by sensing gravity, and interpret a change in orientation of the tag as motion. Of course, the radio frequency communication circuitry provides communication in radio frequency communication environments, to and from the tag, while the optical communication port provides communication functions in systems that utilize that mode of communication. Both modes of communication may be used within a single tracking system but at different locations in the tracking system.

In general operation of the system, a tag monitors the expected frequency for an RF signal or field. When it is in the zone of a particular RAD, the signal of that RAD will overpower the incidental signals of other RADs, and the tag will be able to decode the ID of the respective RAD from the RF field. The tag then transmits a signal at a different frequency. This signal from the tag will have two items of information encoded on it. One item is the ID of the RAD which it has decoded from the surveillance field and the other item is the ID of the tag. Each RAD monitors the frequency of the tags for signals. When a RAD detects a tag transmitting a signal with its own RAD ID encoded on it, it decodes the ID of the tag and notes it as being within its zone and its inventory. RADs may receive tag signals from the zones of nearby RADs, but those signals will not have their ID encoded on them, so the RADs will ignore these signals from tags outside their zone.

Several behaviors may be programmed into tags to save battery life and to prevent their talking over each other. When a tag is attached to an item and introduced into a monitored area, it will be introduced directly into the zone of a RAD, as opposed to a grey area, and this will establish the tag within the system. Once the tag is associated with a RAD, that RAD can confirm with the tag the completion of the association. In some embodiments of the system, the tags may be programmed to cease to transmit after the confirmation, but to continue to monitor the field. If a tag decodes a new RAD ID, the tag then retransmits that RAD ID along with its own ID until it receives confirmation from the new RAD. The new RAD adds the tag to its zone inventory and communicates its recordation to the system. The previous RAD receives notice from the system that the tag has moved out of its zone and removes it from its local inventory. In this way, that tag only transmits when it decodes a new RAD ID, and this limits the amount of transmitting required of a tag, which extends the life of the power supply.

Alternatively, as a RAD adds a tag to its inventory, it may communicate an ordinal number to the tag. Periodically, the RAD transmits an inventory request signal to its zone. Upon the transmission of this inventory signal, the tags in the RAD's zone begin to transmit in the order of the ordinal number assigned to them according to an increment of time multiplied by the ordinal number. The tags transmit the RAD ID and their own ID. The RAD monitors the tag frequency for the tag transmissions. In this embodiment, the tags transmit when they decode a new RAD ID and also when they are prompted by their associated RAD. By transmitting according to their assigned order, the tags avoid interfering with each other's signal. When a RAD unit is informed that another RAD has acquired one of its tags, it can communicate a new order to its tags.

Tags which have associated with a RAD unit, but then moved to a grey area of overlap between their associated RAD unit and another RAD unit, may be inaccessible. These tags will be able to detect and monitor the RAD field, but the tags will not be able to decode the IDs of the RADs or other communications from the RADs. Since, the tags will decode a new RAD ID when the tag moves more clearly into the zone of a RAD, this is a temporary situation. Some embodiments of the system may execute more extensive inventories during operational lulls such as when a facility is closed. For example, when a store is closed, the system may run an inventory through RAD while other RADs are silent. In these inventories, tags would reply to their most recent associated RADs. Without other RAD signals interfering, a RAD would be able to inventory its surrounding grey zones.

In embodiments where the tag also comprises a motion detector, the electronics of the tags are normally idle, except for the motion sensor and the limited requirements on the microprocessor to monitor the motion sensor. When the motion sensor indicates that the tag is in motion, the rest of the electronics begin to have roles. When the tags are activated, the radio frequency communication circuitry of the tags monitor for radio frequency signal in RAD frequency, or fields, that they expect to detect. If the RAD ID of an already associated RAD is decoded, no action is taken. If a new RAD ID is decoded, the tag transmits a signal to associate with the new RAD.

Whether tags have a motion detector or not, any time a tag is armed and the expected fields, or signals, are not detected by the radio frequency communication circuitry of a tag, the tags will self alarm and produce an alarm. In some embodiments, this alarm may be an audible alarm to notify surrounding persons. In other embodiments, the alarm may be a radio signal alarm detectable by other elements of the system. The total absence of a signal, or field, indicates to the tag that it has been removed from the monitored area. If the tag has not be disarmed, this is interpreted as an attempt at theft. Again, is some grey areas, the tags may be unable to decode the signal, but the field will still be detected, indicating that the tag is within the monitored area.

In tags comprising motion detectors, if the expected signal fields are detected by the radio frequency receivers, the tags will simply continue to monitor for the signal fields for a predetermined time after the tags come to rest. Once the tags are at rest for the predetermined period, the tags will go idle again, except for the motion sensor and monitoring microprocessor. Receivers in addition to the monitoring RADs can be placed at locations where tag alarm signals are anticipated so that tag signals need not be overly powerful and drain the onboard battery. The infrequent broadcast by the tags, along with the shorter range required of the signal, reduces drain on the power source and greatly extends the life of a tag.

The radiating units have external power sources ultimately based on the ubiquitous alternating current system and therefore are not limited in their power capabilities as the tags are. In at least one embodiment, the radiating units use a characteristic of the mains power system to synchronize their transmission of signals. A typical characteristic that is used is a zero crossing of a phase of the mains power supply alternating current. In at least one embodiment, the signal radiating units have power transformers to convert the available power to a different voltage required for the electronics of the signal radiating units. By being synchronized, the radiating units can each generate a field in phase with its neighbors so that the field is maintained even though there may be areas where neighboring radiating units prevent each other's information from being decoded from the field.

The use of several radiating units allows the signal field of the protected area to be closely tailored to the physical contours of the protected area. Additionally, some radiating units may transmit a canceling, or interference, field to attenuate the signal in particular areas. For example, radiating units nearest exits from the protected area may transmit a canceling field so that the monitoring, or interrogation, field is attenuated at the exits but within the physical space of the protected area. In application in a retail environment, this would mean that a tag on an object being improperly removed from the retail store would lose the system signal while still in the store. The tag would then sound an audible alarm while still in the retail store in proximity to store personnel, and receivers located near the exits can pick up RF alarms from an exiting tag. Some embodiments of the system may employ transmitter systems at ground level to generate the canceling field as this may facilitate a highly local effect at an exit or other area where it is desired to cancel the signal. Radiating units transmitting the cancelling field may also use alternating current characteristics of the mains power supply to synchronize with each other as well as with radiating units transmitting the saturating monitoring field. The tags transmit their alarm signals over their own frequency and the receivers monitoring for alarms monitor that frequency.

In addition to the basic anti-theft alarming functions, embodiments of tags are capable of data storage. This capability is helpful for inventory management and theft deterrence. Each tag can store its own identifier and a passcode for security purposes, and some embodiments may store information about the object to which it is attached. A controller associated with the system communicates the object information to the tag, typically when the tag is attached to the object. In at least one embodiment, this communication occurs via radio frequency transmission from a transmitter associated with the controller and received by the transceiver of the tag being attached to the object. The information for the object, the tag identifier, and any passcode, may be stored in a database accessible by the controller such as on an associated computer. On the tag, the data is stored by the microprocessor. In a retail setting, when merchandise is added to an area and tags attached to the merchandise, the information about the object can be transmitted to the tag and the tag identifier assigned to the tag. In some embodiments, a tag may have a permanent identifier, while in other embodiments the tag identifier may be added as the tag is brought into the system. Similarly, once a tag is associated with an object, or piece of merchandise, in a database, the tag identifier is sufficient to identify the object. In at least one embodiment, transmission from the tag is limited to alarming conditions, direct interrogation of the tag by the controller during entry or removal from the system of either the tag or the object being protected, or both, and when a tag decodes a new RAD ID. As discussed above, this limiting of transmissions from the tag greatly lengthens the life of the power supply of the tag, usually a battery.

Embodiments of tags may vary widely in how they releasably attach to the objects they are protecting. The various attaching mechanism available to attach a tag to a protected object include: tack and clutch mechanisms; lanyards; pivoting members clamping around the object, and; adhesive elements. Some embodiments of tags will have tamper detection capabilities which will vary depending on how the tag attaches to an object. For example, lanyard tags may employ a lanyard with a conductive element, so that when a lanyard is cut to remove a tag, an electrical conductive circuit is changed, indicating tampering. Other tags may employ switches to indicate when parts of a tag are being separated without authorization or without the tag being disarmed.

Some embodiments of the tags may carry a passive EAS element. These passive EAS elements work with EAS systems that generate interrogation fields at exits or other areas of interest. There are at least two types of passive EAS elements.

One type of passive element comprises a wire coil and ferrite core. While transmitting, the interrogation field builds up energy in the coil and core element. When the interrogation field ceases, the energy in coil and core elements dissipates and generates a signal that is a harmonic of the interrogation field. The EAS system monitors for these harmonics, and when a harmonic signal is detected, the system determines that a tag is present in the monitored area and an alarm condition is determined.

Another type of passive tag uses two small metal strips. One has a magnetic bias to it, while the other does not. The two strips are arranged in proximity to each other with only limited constraints and together are tuned to resonate when brought into an interrogation field. The resonance produces a signal which the EAS system can detect. Detection of the signal produces an alarm condition in the EAS system.

In addition to alarming when a system signal is not received, some tag embodiments will alarm when an attempt is made to remove the tags from a protected object without authorization. These tags employ switches and other sensing methods to detect when a tag has been removed, or an attempt is being made to remove them, and the tag alarms when that is determined. This tag alarm may be an audible alarm, an alarm signal transmitted at a specified frequency, or both.

### BRIEF DESCRIPTION OF DRAWINGS

Additional utility and features of the invention will become more fully apparent to those skilled in the art by reference to the following drawings, which illustrate some of the primary features of preferred embodiments.

FIG. 1 is a perspective view of an asset protection system according to one embodiment of the invention.

FIG. 2 shows a controller installed at a retail counter.

FIG. 3 is a block diagram representing a radiate and detect unit.

FIG. 4 is a top perspective view of a tack attached tag compatible with at least one embodiment of the asset protection system.

FIG. 5 is an exploded perspective view of the tack attached tag of FIG. 3.

FIG. 6 is a perspective view of a lanyard tag compatible with the intelligent asset protection system.

FIG. 7 is a perspective view of the lanyard tag of FIG. 6 with the outer shell made transparent.

FIG. 8 is a perspective view and an exploded perspective view of a detacher.

FIG. 9 shows an embodiment of the tracking system where the radiate and detect units are network with network cables.

### DETAILED DESCRIPTION OF EMBODIMENTS OF THE INVENTION

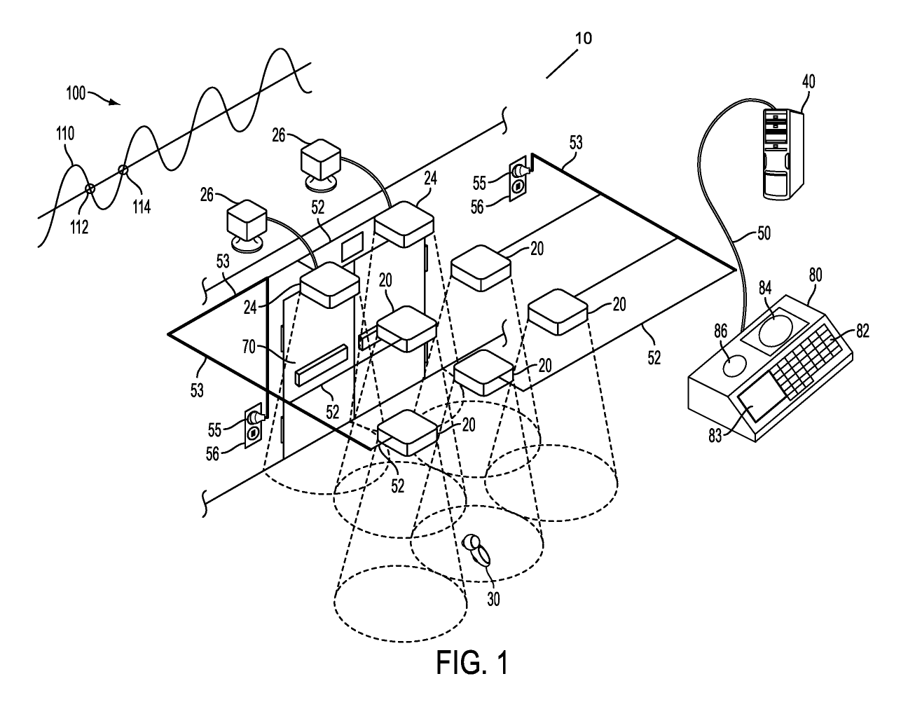

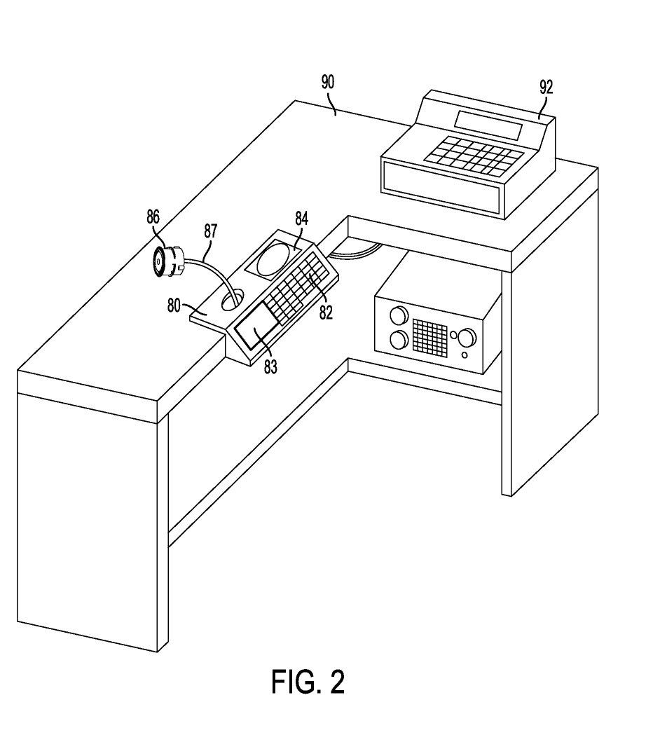

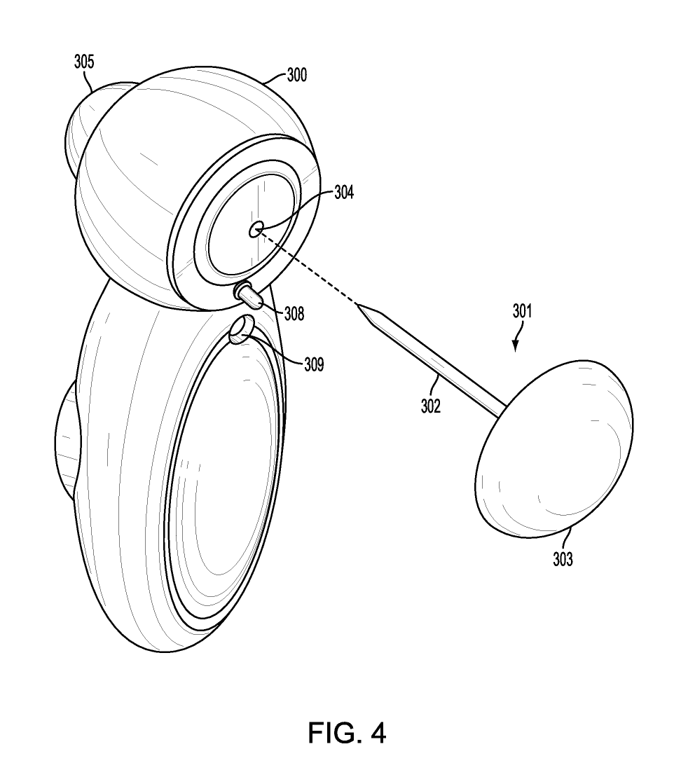

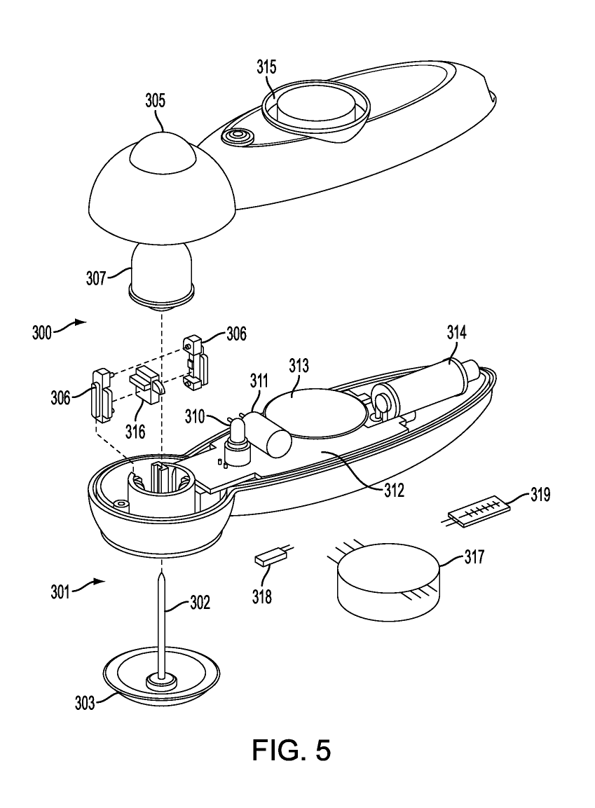

FIG. 1 is an overall view of an embodiment of the asset protection system 10. A plurality of signal, or field, transmission units 20 and 24 are used by the asset protection system 10 to create and shape a monitoring field in a protected area. Signal, or field, transmission units 20 and 24 may also be called radiate and detect units. In one embodiment, each transmission unit 20 and 24 has a programmable controller, memory, signal transmitting and receiving means, and standard power cords 52 for power. Other embodiments may have an onboard power transformer to change the voltage of the power received through power cord 52 to accommodate onboard electronics. The various transmission units 20 and 24 are networked with computer 40. Computer 40 performs database functions and other data intensive functions and connects to interface 80 with cable 50. Interface 80 provides a means of interacting with tags 30, and computer 40 such as performing data entry, and other functions. FIG. 2 further illustrates controller 8, while FIGS. 4 and 5 further illustrate an embodiment of a tag.

Each transmission unit 20 and 24 is independently capable of radiating an area with a radio frequency field, although, as discussed in more detail below, transmission units 20 and 24 perform different functions. In at least one embodiment, transmission units 20 and 24 are mounted overhead with the individual fields generated by each transmission unit expanding as they extend further away from the transmission units. With shielding and directional techniques, a field can be shaped to extend downward from the transmission units to be somewhat conical as it reaches down into the occupied levels of the monitored area. With a sufficient number of transmission units 20 and 24, the entire target area can be covered without intrusive installations at the level where persons and objects will be located. The fields created by signal transmission units 20 overlap to some degree in their initial direct paths, and the signals, or fields, generated by the multiple transmission units 20 will “bounce” around within a monitored area, but each transmission unit 20 will have a zone where its field, or signal, is dominant.

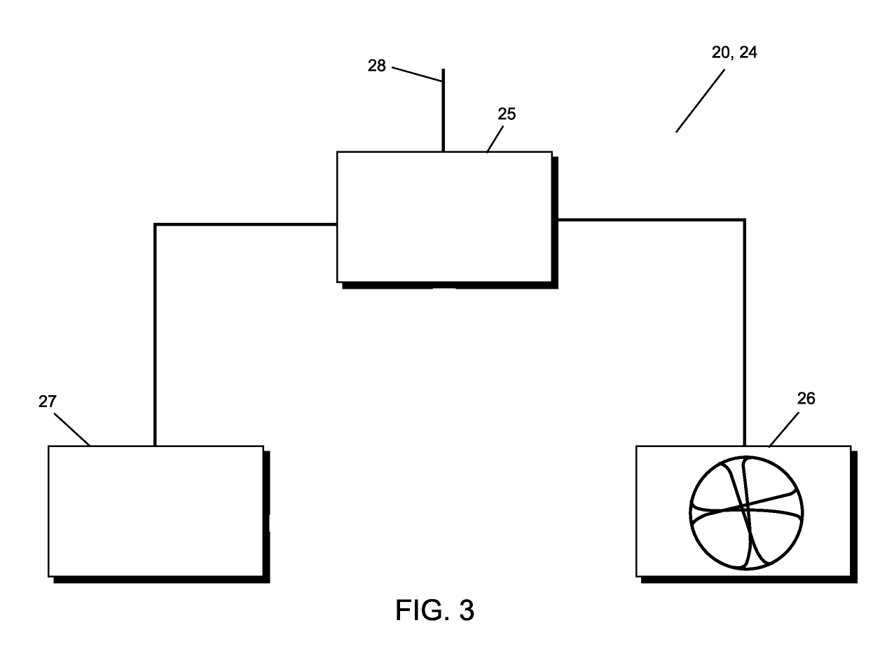

FIG. 3 is a block diagram representing a radiate and detect unit 20, 24. Controller 25 operates radio frequency transmitter and receiver 26, which may function as a transceiver. Controller 25 stores information it receives via transmitter and receiver 26 in memory 27. In some embodiments, memory 27 may be integral to controller 25. Radiate and detect unit 20, 24 receives power from power supply 28. In some embodiments, power supply 28 may be standard 3 phase power. In other embodiments power supply 28 may be an Ethernet cable or other type of network cable. In embodiments where power supply 28 is a network cable, unit 20, 24 can receive information and instructions via power supply 28. The information and instructions may include programming of controller 25. In some embodiments of system 10, unit 20, 24 can communicate with other units 20, 24 via transmitter and receiver 26 for networking purposes. In other embodiments, the network will be formed with Ethernet cables, switches, etc.

A sample tag 30 is shown in FIG. 1 and an embodiment of a tag 30, tag 300, is further illustrated in FIGS. 4 and 5. Tags 30 are releasably attached to items to be protected or tracked. Tags 30 monitor for the presence of the field and for information transmitted by the field, and tags 30 can also generate alarms under particular conditions.

In FIG. 4, tag 300 is attached to an object with tack 301. FIG. 5 is an exploded perspective view of the tack attached tag 300 of FIG. 3, and shows several of the elements internal to tag 300. At the left end of tag 300 are elements associated with attaching tag 300 to an item to be protected, such as clutch housing 307, shaft switch 316, and tack 301. In the center and to the right of tag 300 are electronics elements for active security functions of tag 300. Located within tag 300, and shown attached to circuit board 312, are light emitting diode 310, power source 311, and audible alarm generator 313. Normally attached to the bottom of circuit board 312, in this embodiment of tag 300, but shown outside of tag 300 in FIG. 5 are microprocessor 317, motion sensor 318, and a radio frequency receiving and transmitting circuitry 319. In some embodiments, receiving and transmitting circuitry function as a transceiver. The microprocessor is capable of storing machine readable instructions and executing those machine readable instructions based on inputs from the other elements in tag 300. In many embodiments power source 311 is a battery. However, it is known in the art to power tags with RF fields. In these embodiments, coils onboard the tag receive the field and the output of the coils are rectified to provide power to other elements of the tag. In addition to these powered electronics, passive EAS element 314 is also shown in FIG. 5.

Returning to FIG. 1, signal transmission units 20 transmit a field at a known frequency and, in at least one embodiment, are powered by standard wall outlet power as shown in FIG. 1. Power cords 52 may be connected and bussed together through conduits 53 to plugs 55 at wall outlets 56, or they may be dispersed enough to rely upon their own power cords 52 to plug into wall outlets. As illustrated in FIG. 1 at 100, the mains power supply for asset protection system 10 comprises a sinusoidal voltage wave 110 having characteristic points in the wave such as zero crossing points, two of which are indicated at 112 and 114. Zero crossing point 112 occurs on a decreasing slope of sinusoidal voltage wave 110 and zero crossing point 114 occurs at an increasing slope of sinusoidal voltage wave 110. There are other characteristic points such as maximum, minimums, etc. Signal transmission units 20 and 24 are capable of detecting particular points, such as zero crossing points 112 and 114, in sinusoidal voltage wave 110 and using the detected points as references to synchronize with each other. At times, this synchronization will have the transmission units 20 and 24 transmitting at the same time. At other times, the transmission units 20, 24, may use the synchronization to transmit individually, while other transmission units are silent.

Each transmission unit 20, 24, has a unique unit identifier code which they modulate onto the field, or signal, that they transmit into the monitored area. An EAS tracking tag operating as part of the asset protection system, such as tag 30 shown in FIG. 1, can demodulate information from signals received in the transmission unit frequency. When tag 30 is in a zone where a particular signal field generated by a transmission unit 20 or 24 is sufficiently dominant, tag 30 can demodulate the unique unit identifier code of that unit from its field. When tag 30 demodulates a unit identifier code from the field, it transmits a signal at a frequency distinct from the frequency at which transmission units 20 and 24 transmit. Tag 30 modulates the decoded unit identifier code as well as its own tag identifier code onto its signal at this second frequency.

Transmission units 20 and 24 monitor this second frequency that tag 30 uses to transmit its signal. When a unit 20 or 24 detects a signal on this second frequency, it demodulates both the unit identifier code and the tag identifier code. If the unit identifier code matches its own, the particular unit 20 adds the transmitting tag 30 to its own inventory. It is possible for multiple units 20 or 24 to detect and decode a given tag signal. Those units 20 or 24 that decode a tag signal that does not carry their unit identifier code will not act on the signal.

Having detected tag 30 and added it to its inventory within its own memory, a radiate and detect unit 20 or 24 may take other steps. The unit may transmit a confirmation signal to tag 30. Upon receiving this confirmation signal tag 30 can cease to transmit, conserving its power. In embodiments of tag 30 not employing a motion detector, tag 30 would not transmit again until it is moved to a new zone and decodes a new unit identifier code, upon which event, tag 30 would transmit a signal and be added to the new units inventory. Another step a unit may take after detecting a tag is transmit to the network that it has detected and added the particular tag 30 to its inventory. In situations where a tag 30 has been moved from one unit's zone to another unit's zone, this communication to the network would inform the former unit that a tag has left its zone. Upon detecting a tag in its zone, a unit may also assign and communicate an ordinal number to tag 30 within its own inventory. This ordinal number instructs a tag when to reply if its unit conducts an inventory of its zone. By sending an inventory signal the unit prompts the tags within its inventory to respond in the order of their ordinal number, using a set time interval to time their responses, so that the tag signals do not interfere with each other. Units 20, 24 may also send other instructions to tags.

In some embodiments and applications, some radiate and detect transmission units will perform special functions. For example, in FIG. 1, units 24 are located near exit 70. This positions units 24 to track tags 30 entering and leaving exit 70. In anti-theft applications units 24 will be monitoring for tags leaving at exit 70. Tag 30 is detachable and will be detached from a retail article when processed at a checkout counter such as checkout counter 90 in FIG. 2. When unit 24 receives a signal from a tag that has moved into its dominant zone, unit 24 determines a theft is being attempted and can take actions. These actions may include sounding an alarm via associated audible alarm generators 26, communicating to the network that theft is being attempted, or instructing the signaling tag sound an audible alarm. Although units 24 in FIG. 1 are shown mounted overhead, they could also be mounted beneath the floor, in pedestals flanking the exit, or a combination of locations could be used to insure exit 70 is thoroughly and tightly covered. Other than their task specific programming, units 24 are the same as units 20, and physically interchangeable.

Tag 30 may also programmed to alarm without instruct from units 24. As part of the configuration of the system, the identifier codes of units 24 at security locations such as exit 70 will be recorded within the system, in particular, in computer 40. When tag 30 and its associated object are introduced to the monitored area, tag 30 can be programmed with the identifier codes of units 24 that are placed at security locations. When tag 30 demodulates the previously flagged identifier code of a unit 24, tag 30 executes its own safety protocol as defined machine readable instructions programmed into its microprocessor, such as audibly alarming and transmitting an alarm signal at the tag frequency. The tag may modulate its tag identifier code onto the alarm signal.

Referring still to FIG. 1, interface 80 is connected to computer 40 by cable 50. The embodiment of interface 80 shown in FIG. 1 has a keypad 82 for command and data entry, a display screen 83, a communication pad 84 for radio frequency communication with tag 30, and a detacher 86 for allowing tags 30 to be detached from objects. FIG. 2 shows interface 80 installed at a checkout counter 90 in a retail application. Also shown in FIG. 2 is a cash register 92. In retail environments, most products and protected objects will be processed out of the monitored area via a checkout counter like the one shown in FIG. 2 at checkout counter 90. Communication pad 84 of interface 80 is comprised of transmitting and receiving elements that can communicate via RF frequency signals with tag 30, which is attached to protected objects being checked out of the monitored area, or store. The transmitting and receiving elements of communication pad 84 are sometimes combined into transceivers. The transmitting capabilities of tag 30 used to broadcast an RF alarm signal can also transmit information to communication pad 84, while the receiving capabilities of tag 30 can receive information from communication pad 84.

Communication pad 84 can exchange data information with tag 30 as well as making changes to the machine readable instructions stored on a microprocessor in tag 30. The close proximity of communication pad 84 with tag 30 at checkout decreases the strength of signal that tag 30 needs to transmit. At checkout, interface 80 can query tag 30 to receive from the tag 30 the unique identifier that was assigned to tag 30 at a previous point in time. Interface 80 can also receive from tag 30 information about the object to which tag 30 is attached. This information about the object can be imparted to tag 30 at the time tag 30 is attached to the object. Alternatively, the unique identifier assigned to tag 30 can be associated with the object and its information within a relational database at the time that tag 30 is attached to the object. In the relational database, knowledge of the identifier of the tag is then sufficient to know to which object that tag is attached. When the object is checked out, the system can record and date stamp the transaction and remove the object from inventory. Information about the transaction can be recorded such as an employee identifier, customer identifier, etc. The ability to store an employee identifier aids in prevention of internal theft as well as other employee management tasks. The ability to store a customer identifier with a transaction allows a retailer to develop customer profiles, etc. Keypad 82 facilitates interaction between a user and the system and display screen 83 provides visual information for the user.

In the embodiment shown in FIG. 2, interface 80 also has detacher 86 associated with it. Detacher 86 facilitates the detachment of tag 30 from the object, and in at least one embodiment detacher 86 has a magnet which, when detacher 86 is brought into proximity to a tag, facilitates the release of the tag from the object. In FIG. 2, detacher 86 is shown removed from a nest in interface 80 so that it may be brought into close enough proximity with a tag to allow it to be release from the object being protected. Detacher 86 is maintained in association with interface 80 by cable or tether 87. Some embodiments of tags are programmed to determine an alarm condition and to alarm when a tag is removed from an object without authorization. In those situations, communication pad 82 of interface 80 can deactivate, or disarm, a tag prior to the tag's detachment from the object. In programmable embodiments, this disarming is accomplished by changing a setting in the machine readable instructions of a microprocessor carried within the tag.

Some embodiments of the asset protection system will employ passcodes. An anti-theft tag 30 can store a security passcode. When interface 80 interacts with tag 30, it can transmit the passcode to tag 30 which compares the transmitted passcode to a value stored by tag 30. If the passcode transmitted by interface 80 to tag 30 and the stored value match, tag 30 disarms and it may be released from the item to which it is attached without an alarm being generated. If the system employs a unique passcode for each tag 30, then interface 80 must first receive a unique identifier associated with a given tag 30. With that information, interface 80 can determine the correct passcode and transmit it to tag 30 to disarm tag 30. An incorrect passcode will not cause tag 30 to disarm and subsequent removal of tag 30 will cause an alarm condition.

Some embodiments of the EAS system may employ time base algorithms to periodically change passcodes. In those cases, each tag will also have an onboard clock. At specified intervals, the passcode is changed according to the algorithm. If each tag has a unique passcode, the system, which will also have at least one clock, can track the changing passcodes for each tag based on knowing a tags passcode at some given initial time. Other embodiments of the system, may use a single passcode system wide. In this embodiment, each element has a clock and the same passcode at any given time. At specified intervals, each element updates its own passcode according to the algorithm to a new passcode which is the same for each element in the system.

Each interaction between the system at large and a tag 30 is trackable and recordable by the system's server and computer elements. When a tag 30 is applied to an object to be protected, the tag and its associated object is entered into the database functions of the system. Because a tag is only required to communicate with receivers in relatively close proximity to it, a tag does not need to expend excessive energy transmitting information to the system at large. Both the communication pad 82 of interface 80 and the interference units 24 can be located to provide close proximity to tags 30. Communication pad 82 and interference units 24 are not limited in their access to power as are tags 30.

Some embodiments of tag 300 may comprise a motion detector 318. When the object to be protected and the associated tag 300 are still, the powered electronic elements of tag 300 are normally dormant except for motion sensor 318 and microprocessor 317. Microprocessor 317, however, operates in a minimized mode, being only active enough to monitor motion sensor 318. When tag 300 is moved, motion sensor 318 detects the motion, triggering microprocessor 317 to switch to an active mode and monitor RF circuitry 319 for information. If RF circuitry 319 demodulates a unit identifier code from the RF field in the monitored area, tag 300 transmits a signal at the tag transmission frequency with the unit identifier code and its own tag identifier code modulated onto the signal. Upon receipt of the tags signal, the respective radiate and detect unit 20, 24 reacts as programmed. In embodiments of tags 300 with motion detector switch 318, tags 300 conserve energy while the tag is at rest, but transmit a signal most times when tag 300 is moved. In embodiments of tags 300 without a motion detector 318, tags 300 monitor the field consistently, but only transmit a signal when a new unit identifier code is demodulated from the field, or periodically retransmit a current unit identifier code when so programmed.

If a person attempts to block the signal from tag 300 by, for example, wrapping tag 300 in metal foil, the result will be the same as if tag 300 is removed from the monitored area. Since tag 300 will not receive the signal and won't be able to decipher a code transmitted on the signal, it will determine an alarm condition. In addition to an audible alarm generated by audible alarm generator 313, tag 300 can send out a radio frequency alarm at the tag transmission frequency with RF circuitry 319.

Once audible alarm generator 313 begins to alarm, it continues to alarm until conditions are met to cease alarming. These conditions can vary depending on the preferences of the user of the system. One condition may simply be the resumption of the RF field or signal, i.e. the return of tag 300 to the protected area where radio frequency receiver 319 can detect the field. Another condition may be an instruction to cease alarming modulated onto the radio frequency signal by a radiate and detect unit 20, 24. This instruction to cease alarming can be initiated by authorized personnel. Another condition that may cause tag 300 to cease alarming may be depletion of power source 311.

There are various approaches to determining whether tag 300 is being moved. In one embodiment, motion sensor 318 employs an accelerometer, such as a piezoelectric accelerometer, to directly detect that tag 300 is being moved. In another embodiment, motion sensor 318 actually monitors the orientation of tag 300 by sensing gravity. If the direction of gravity changes, then motion sensor 318 determines that tag 300 has changed its orientation and is being moved.

Some embodiments of tag 300 will alarm under other circumstances in addition to not detecting an expected RF field or demodulating a flagged unit identifier code from the field. Cap switch 308, shown in FIG. 4, and shaft switch 316 shown in FIG. 5, provide indications of tampering if their state changes without the electronics of tag 300 being disarmed by interface 80. When tack shaft 302 is inserted into tag 300, shaft switch 316 is actuated by tack shaft 302. Similarly, when a tag 300 is attached to an object and a layer of material is caught between tag cap 303 and the body of tag 300, cap switch 308 is actuated. Actuation of either switch can be used to arm tag 300 to begin monitoring for a radio frequency signal, and a later change in status for either switch can be used to trigger an audible alarm by alarm generator 313. If cap switch 308 or shaft switch 316 experience a change in state without tag 300 being disarmed, then the electronics of tag 300 determine that tack 301 has been removed from tag 300 without authorization and an audible alarm can be sounded by audible alarm generator 313 or tag 300 may also transmit an RF alarm signal, or both.

Passive EAS element 314 shown in FIG. 5 adds an additional security feature. EAS element 314 operates with EAS systems in which interrogation fields are established at exits or other control areas. Some passive EAS elements are comprised of a coil and core construction. When the interrogation field is active it builds up energy in the core and coil. When the interrogation field is temporarily discontinued, the energy dissipates from the core and coil assembly and generates a signal that is a harmonic of the original interrogation field. The EAS system monitors for these signals and if one is detected, the system determines that a tag is present in the interrogation field and an alarm may be generated. Other passive tags are comprised of two metallic strips which are loosely mounted in proximity to each other. The two strips are designed and sized to resonate when placed in the interrogation zone. The EAS system is tuned to detect the signal from the resonant EAS tags. Passive EAS element 314 is depicted as the coil and core type. However, tag 300 could just as easily carry the resonant style of tags.

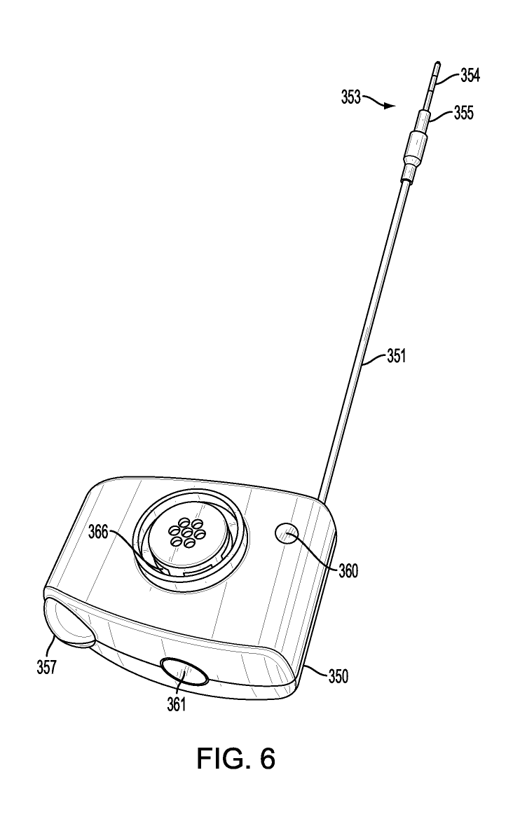

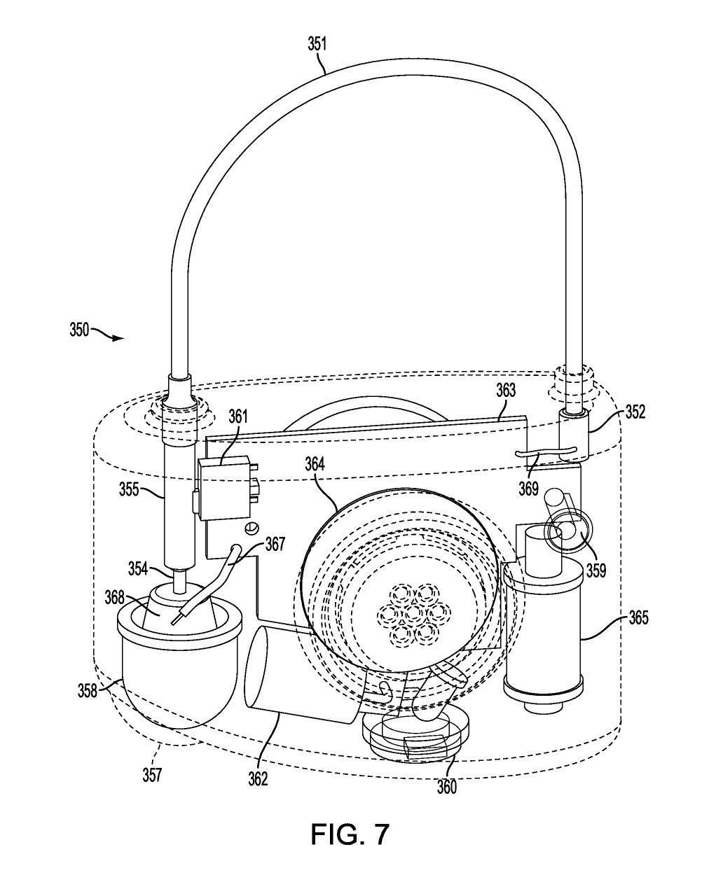

FIG. 6 is a perspective view of a lanyard tag compatible with the intelligent asset protection system. FIG. 7 is a perspective view of the lanyard tag of FIG. 6 with the outer shell made transparent. As may be seen in FIG. 7, lanyard tag 350 is capable of carrying the same electronics as tag 300 of FIGS. 4 and 5. Visible in FIG. 7 are circuit board 363, battery 362, audible alarm generator 364, and passive EAS element 365. Not visible in FIG. 7 is a microprocessor, motion detector, and radio frequency receiver which are mounted on the opposite side of circuit board 363 in the embodiment shown in FIG. 7.

Although lanyard tag 350 shown in FIGS. 6 and 7 operates in the asset protection system essentially the same as tag 300 of FIGS. 4 and 5, lanyard tag 350 attaches to an object to be protected with a different mechanism and therefore the tamper indicators in lanyard tag 350 are different. Lanyard tag 351 attaches to an object to be protected by encircling some portion of that object with a lanyard. Lanyard 351 has a permanently anchored end 352 and a coupler end 353, and, in some embodiments, along its length, some portion of lanyard 351 is made of an electrically conductive material. In particular, many embodiments of lanyard tag 350 will have a lanyard 351 having its core made of an electrically conductive cable. Coupler end 353 of lanyard 351 has a retention pin 354 section and a contact cylinder 355 section. To retain lanyard tag 350 on an article, lanyard 351 is passed through the article and retention pin 354 is inserted into aperture 356, where it is retained by a mechanism located in lanyard tag 350. Alternatively to passing lanyard 351 through an article, lanyard 351 may be passed around some location on an article where it may not be easily removed. In one embodiment of tag 350, the mechanism that retains retention pin 354 in aperture 356 is a ball clutch which can be made to release retention pin 354 by application of a magnet to clutch cone 357 visible on the bottom of lanyard tag 350 in FIGS. 6 and 7. In some embodiments, clutch housing 358, visible in FIG. 7, has at least some magnetically attractable material in it, and is the element acted upon by the magnet to release retention pin 354.

In addition to alarming when it is being moved and no system signal is detected, lanyard tag 350 is capable of self alarming upon the occurrence of any one of several events. One event that can trigger self alarming by tag 350 is physical tampering with the tag. A common attack used against lanyard type tags is the cutting of the lanyard. Referring to FIG. 6, once coupler end 353 of lanyard 351 is inserted through aperture 356 and into retention mechanism 368, two tamper detection circuits are completed. A first tamper detection circuit includes clutch wire 367, retention mechanism 368, retention pin 354, contact cylinder 355, and switch 361 and is completed on circuit board 363 (microprocessor, etc.). This first tamper detection circuit establishes that coupler end 353 of lanyard 351 has been inserted. A second tamper detection circuit includes lanyard wire 369, lanyard 351 and can be completed by two possible routes. One completion route includes contact cylinder 355, switch 361, and circuit board 363 (microprocessor, etc.). Another completion route includes retention pin 354, retention mechanism 368, clutch wire 367 and circuit board 363 (microprocessor, etc.). This second tamper detection circuit monitors the integrity of lanyard 351. If lanyard 351 is cut, the first tamper detection circuit is still completed, while the second detection circuit is opened. When tag 350 detects that lanyard 351 has been cut, it self alarms with audible alarm generator 313 generating an audible sound. Some embodiments of tag 350 will self alarm when the body of tag 350 is opened or otherwise compromised. In this case the self alarm may be triggered by the displacement of circuit board 363 or other means.

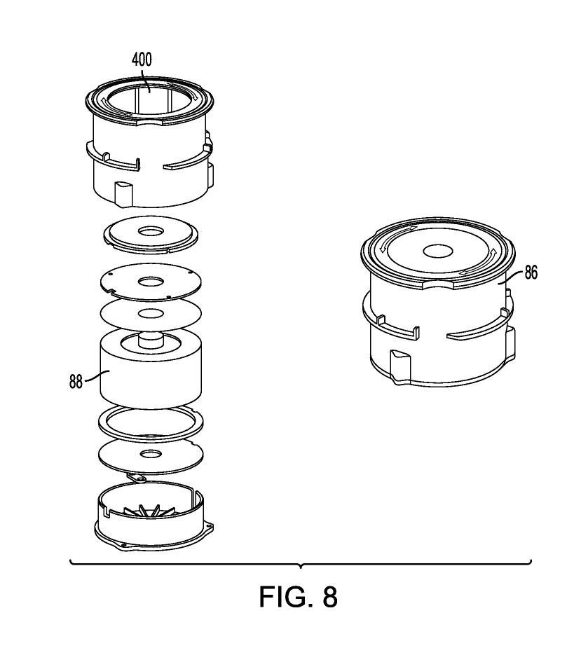

FIG. 8 is an exploded view of an embodiment of a detacher 86. Detacher 86 has a magnet 88 sufficiently strong to allow detachment of tag 300 or tag 350 from an object. Application of detacher 86 to the appropriate area of a tag actuates a release mechanism having a magnetically attractable portion in it.

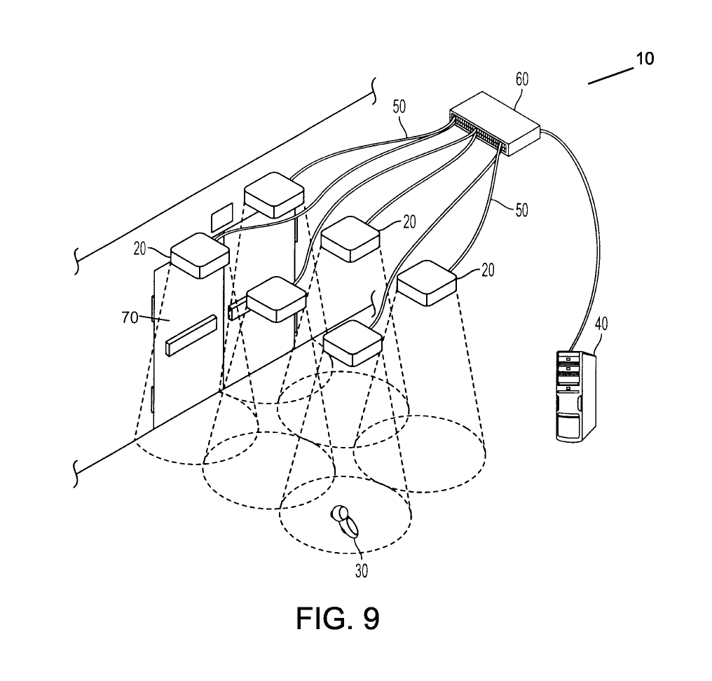

FIG. 9 shows an embodiment of the tracking system where radiate and detect units 20, 24 are networked with network cables 61. Units 20, 24 are networked with computer 40 and each other via network switch 60. Ethernet is a common networking system for such applications. In the embodiment of FIG. 9, units 20, 24 receive both power and communications over network cables 61.

It is to be understood that the embodiments and claims are not limited in application to the details of construction and arrangement of the components set forth in the description and illustrated in the drawings. Rather, the description and the drawings provide examples of the embodiments envisioned, but the claims are not limited to any particular embodiment or a preferred embodiment disclosed and/or identified in the specification. The drawing figures are for illustrative purposes only, and merely provide practical examples of the invention disclosed herein. Therefore, the drawing figures should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations. Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

While, for explanatory reasons, retail applications have been discussed in more detail, other embodiments of the invention may be used to track persons. For example, embodiments of the invention may be used to track newborns at hospitals, elderly people at assisted living facilities, and inmates of corrections facilities where it is desirable to monitor the presence of a person within an area. In those cases, FIG. 2 can be thought of as illustrating a nurses' station or an administrators' station, and the term “item” would apply to a person wearing an embodiment of a tag of the present invention. Additionally, any operation that needs to maintain control of assets within a given area, such as an R&D group, would benefit from an application of an embodiment of the invention.

I claim:

1. A tracking system comprising;
a plurality of radiate and detect units networked together with a central computer, each unit comprising a radio frequency transmitter and receiver, a processor with memory, and a power supply, and each said unit having a unique unit identifier code;
at least one tracking tag, said at least one tracking tag comprising an attaching mechanism and electronic components, said electronic components comprising a microprocessor, an audible alarm generator, a power source, and radio frequency circuitry, said radio frequency circuitry being capable of transmitting and receiving radio frequency signals and detecting said monitoring field, each said tag having a unique tag identifier code;
wherein;
each of said units transmits a field of a first frequency into an area to be monitored, each said unit modulating its own unit identifier code onto its transmission of said field;
when a tag is placed in said area to be monitored, said tag monitors said first frequency for said field and when said tag decodes a unit identifier code from said field, said tag transmits a signal at a second frequency, said tag modulating the decoded unit identifier code and its own tag identifier code onto said signal at said second frequency; and,
each of said units monitoring said second frequency for signals carrying their own unit identifier code, and adding the originating tag of those signals to their inventory for their area.

2. The tracking system of claim 1, wherein;
said tracking tag is attached to an inanimate object by said attaching mechanism.

3. The tracking system of claim 1, wherein;
a unit transmits a confirmation signal to a tag when it receives that tag's signal.

4. The tracking system of claim 3, wherein;
a tag ceases to transmit when it receives a confirmation signal from a unit and begins to transmit again when it decodes a new unit identifier code.

5. The tracking system of claim 1, wherein;
when a unit acquires a tag, the unit communicates the tag identifier code to the network.

6. The tracking system of claim 1, wherein;
each unit periodically polls the tags within its recorded inventory to confirm its inventory.

7. The tracking system of claim 1, wherein;
said electronic components further comprise a motion detector;
wherein, when said motion detector has not detected any motion of said tag for a preset period of time, the electronic components enter a reduced state of operation wherein only said microprocessor and said motion detector are active.

8. The tracking system of claim 1, wherein;
said power source is a battery.

9. The tracking system of claim 1, further comprising;
a database maintaining information about what each tag is attached to.

10. The tracking system of claim 1, wherein;
said units are networked with said central computer via a wireless network.

11. The tracking system of claim 1, wherein;
said units are networked with said central computer via a Ethernet cable network.

12. The tracking system of claim 11, wherein;
said power supply for said units is the Ethernet network.

13. The tracking system of claim 1, wherein;
the power supply for said units is a standard three phase alternating current and the units synchronize with each other based on a single phase of the three phases.

14. The tracking system of claim 1, wherein;
said tag is armed at the time of attachment;
said tag alarms if detached without being disarmed;
said tag is disarmed by a disarming signal from a disarming device external to said tag;
said eternal device being a component of the tracking system.

15. The tracking system of claim 14, wherein;
said disarming signal comprises a passcode internal to the tracking system.

16. The tracking system of claim 15, wherein;
said tag comprises an internal clock; and
said network comprises an internal clock; and,
the microprocessor of said tag executes a time based algorithm to periodically change said passcode,
while said network executes the same time based algorithm to track the changes in said passcode.

17. The tracking system of claim 14, wherein;
said disarming device is a unit.
